(19) United States
(12) Patent Application Publication
(10) Pub. No.: US 2026/0289437 A1
(43) Pub. Date: Sep. 24, 2026

(54) PASSENGER FLOW PREDICTION METHOD, APPARATUS AND SYSTEM

(71) Applicant: CRSC COMMUNICATION & INFORMATION GROUP COMPANY LTD., Beijing (CN)

(72) Inventors: Jing LUO, Beijing (CN); Xiangbin KONG, Beijing (CN); Yang LIU, Beijing (CN); Hongyan LI, Beijing (CN); Yizu LI, Beijing (CN); Yuanyuan LIU, Beijing (CN); Xuesong WANG, Beijing (CN)

(21) Appl. No.: 18/996,027

(22) PCT Filed: Sep. 5, 2023
(86) PCT No.: PCT/CN2023/116913

§ 371 Date: Jan. 17, 2025

(30) Foreign Application Priority Data
Oct. 19, 2022 (CN) 202211278955.4

(51) Int. Cl. G06Q 10/04; G06N 20/00; G06Q 50/40; G06V 20/52

(52) U.S. Cl. CPC G06Q 10/04; G06N 20/00; G06Q 50/40; G06V 20/53

(57) ABSTRACT

The present disclosure relates to a passenger flow prediction method, apparatus and system, and belongs to the technical field of passenger flow prediction. The passenger flow prediction method includes: obtaining a communication relationship between each preset node in a preset region and an adjacent node thereof, where the preset region includes a plurality of preset nodes and connection channels between the preset nodes, and the communication relationship represents a flow direction of a corresponding connection channel; obtaining passenger density information corresponding to the plurality of preset nodes; and predicting passenger flow information in the preset region according to the passenger density information corresponding to the plurality of preset nodes, and the communication relationship between each preset node and the adjacent node thereof.

### TECHNICAL FIELD

The present disclosure relates to the technical field of passenger flow prediction, and specifically relates to a passenger flow prediction method, apparatus and system.

### BACKGROUND

Cameras are generally mounted in station waiting halls or subway platforms to facilitate monitoring of passenger flow conditions in different regions.

### SUMMARY

Embodiments of the present disclosure provide a passenger flow prediction method, apparatus and system, an electronic device, and a computer-readable storage medium, which can accurately predict passenger flow information in a certain preset region to ensure safety of the preset region.

In a first aspect, an embodiment of the present disclosure provides a passenger flow prediction method, including: obtaining a communication relationship between each preset node in a preset region and an adjacent node thereof, wherein the preset region includes a plurality of preset nodes and connection channels between the preset nodes, and the communication relationship represents a flow direction of a corresponding connection channel; obtaining passenger density information corresponding to the plurality of preset nodes; and predicting passenger flow information in the preset region according to the passenger density information corresponding to the plurality of preset nodes, and the communication relationship between each preset node and the adjacent node thereof.

In some embodiments, after obtaining the communication relationship between each preset node in the preset region and the adjacent node thereof, and before obtaining the passenger density information corresponding to the plurality of preset nodes, the method further includes:
constructing an adjacency topological model according to the plurality of preset nodes and the communication relationship between at least one of the preset nodes and the adjacent node thereof, wherein the adjacency topological model is represented in an N^{th} order square matrix form, where N is an integer greater than 1.

In some embodiments, obtaining the passenger density information corresponding to the plurality of preset nodes includes:
obtaining multiple frames of images to be processed, wherein the images to be processed are images obtained by capturing images of passengers at each preset node with at least one image capture device provided at each preset node; and
analyzing the multiple frames of images to be processed according to a deep learning algorithm to determine the passenger density information corresponding to at least one of the preset nodes.

In some embodiments, before obtaining the passenger density information corresponding to the plurality of preset nodes, the method further includes:
determining whether surveillance cameras are present in the plurality of connection channels; and
under the condition that surveillance cameras are present in the connection channels, collecting passenger flow information in the plurality of connection channels according to a passenger flow statistical algorithm, respectively, to obtain passenger flow statistical information corresponding to the plurality of connection channels.

In some embodiments, the passenger flow statistical information includes: the number of passengers passing through each connection channel; and
predicting the passenger flow information in the preset region according to the passenger density information corresponding to the plurality of preset nodes, and the communication relationship between each preset node and the adjacent node thereof includes:
determining a flow direction of each connection channel according to the communication relationship between each preset node and the adjacent node thereof;
determining a weight coefficient matrix corresponding to each connection channel according to the flow direction of the connection channel;
determining a linear estimation model according to the weight coefficient matrix, the passenger density information and the number of passengers passing through the connection channel; and
predicting the passenger flow information in the preset region according to the linear estimation model to obtain a regional flow prediction result.

In some embodiments, the passenger flow statistical information further includes: channel statistical error information; and
before predicting the passenger flow information in the preset region according to the linear estimation model to obtain the regional flow prediction result, the method further includes:
adjusting the linear estimation model according to the channel statistical error information and preset total passenger flow information of the preset nodes to obtain an updated linear estimation model.

In some embodiments, after predicting the passenger flow information in the preset region according to the passenger density information corresponding to the plurality of preset nodes, and the communication relationship between each preset node and the adjacent node thereof, the method further includes:
updating the passenger density information and/or the passenger flow statistical information every preset time interval.

In some embodiments, each preset node includes: an entrance and an exit; and
obtaining the passenger density information corresponding to the plurality of preset nodes includes:
obtaining first communication interaction information passing through the entrance of each preset node, wherein the first communication interaction information is information between a device carried by each passenger passing through the entrance and a preset device provided at the entrance,
obtaining second communication interaction information passing through the exit of each preset node, wherein the second communication interaction information is information between a device carried by each passenger passing through the exit and a preset device provided at the exit; and
determining the passenger density information corresponding to the preset node according to the first communication interaction information and the second communication interaction information; wherein the preset nodes include: at least one of an inbound node, a safety inspection node, a ticket checking node, a waiting node or a riding platform node.

In a second aspect, an embodiment of the present disclosure provides a passenger flow prediction apparatus, including: a first obtaining module configured to obtain a communication relationship between each preset node in a preset region and an adjacent node thereof, wherein the preset region includes a plurality of preset nodes and connection channels between the preset nodes, and the communication relationship represents a flow direction of a corresponding connection channel; a second obtaining module configured to obtain passenger density information corresponding to the plurality of preset nodes; and a prediction module configured to predict passenger flow information in the preset region according to the passenger density information corresponding to the plurality of preset nodes, and passenger flow statistical information in the plurality of connection channels.

In a third aspect, an embodiment of the present disclosure provides a passenger flow prediction system, including: a first image capture device provided in each of a plurality of preset nodes, a second image capture device provided in each of a plurality of connection channels between the preset nodes, and a passenger flow prediction apparatus; wherein the first image capture device is configured to capture images of passengers in a preset node corresponding to the first image capture device to obtain multiple frames of images to be processed, and send the multiple frames of images to be processed to the passenger flow prediction apparatus, so that the passenger flow prediction apparatus analyzes the multiple frames of images to be processed according to a deep learning algorithm to determine the passenger density information corresponding to at least one of the preset nodes; the second image capture device is configured to capture a passenger movement image in a corresponding connection channel between the preset nodes, to obtain and analyze a channel image to obtain passenger flow statistical information corresponding to the connection channel, and send the passenger flow statistical information to the passenger flow prediction apparatus, so that the passenger flow prediction apparatus collects passenger flow information in the plurality of connection channels according to a passenger flow statistical algorithm, respectively, to obtain passenger flow statistical information corresponding to the connection channel; and the passenger flow prediction apparatus is configured to perform any passenger flow prediction method according to the present disclosure.

In a fourth aspect, an embodiment of the present disclosure provides an electronic device, including a memory, a processor, and a computer program stored on the memory and executable by the processor, wherein the processor, when executing the computer program, implements any passenger flow prediction method provided in the embodiments of the present disclosure.

In a fifth aspect, an embodiment of the present disclosure provides a computer-readable storage medium storing a computer program thereon which, when executed by a processor, causes any passenger flow prediction method provided in the embodiments of the present disclosure to be implemented.

In the embodiments of the present disclosure, by obtaining the communication relationship between each preset node in the preset region and the adjacent node thereof, whether connection channels are present between a plurality of preset nodes in the preset region, as well as a flow direction of each connection channel, can be determined for subsequent processing; by obtaining passenger density information corresponding to the plurality of preset nodes in the preset region, the passenger density conditions in different preset nodes can be clarified to facilitate control of the number of passengers in different preset nodes, where the preset region includes a plurality of preset nodes and connection channels between the preset nodes; and by predicting passenger flow information in the preset region according to the passenger density information corresponding to the plurality of preset nodes, and the communication relationship between each preset node and the adjacent node thereof, accurate prediction of passenger flow information in the preset region can be implemented, which can help to schedule and manage the passenger flow between different preset nodes, and thus improve safety in the preset region.

It should be understood that the foregoing general description and the following detailed description are merely exemplary and explanatory, and are not intended to limit the present disclosure. Further features and aspects of the present disclosure will become apparent from the following detailed description of exemplary embodiments with reference to the attached drawings.

### BRIEF DESCRIPTION OF DRAWINGS

FIG. 1 shows a schematic flowchart of a passenger flow prediction method according to an embodiment of the present disclosure.

FIG. 2 shows a schematic flowchart of a passenger flow prediction method according to an embodiment of the present disclosure.

FIG. 3 shows a schematic diagram of passenger density statistics in a preset node according to an embodiment of the present disclosure.

FIG. 4 shows a block diagram of a passenger flow prediction apparatus according to an embodiment of the present disclosure.

FIG. 5 shows a block diagram of a passenger flow prediction system according to an embodiment of the present disclosure.

FIG. 6 shows a schematic flowchart of a working method of a passenger flow prediction system according to an embodiment of the present disclosure.

FIG. 7 shows a schematic diagram of an adjacency topological model according to an embodiment of the present disclosure.

FIG. 8 shows a block diagram of an electronic device according to an embodiment of the present disclosure.

FIG. 9 shows a block diagram of an electronic device according to an embodiment of the present disclosure.

### DETAIL DESCRIPTION OF EMBODIMENTS

The present disclosure will now be further described in detail below in conjunction with the drawings and embodiments. It will be appreciated that the specific embodiments described herein are used merely for the purpose of explaining the present disclosure instead of limiting the present disclosure. It should be further noted that, for the convenience of description, merely some of the structures associated with the present disclosure, not all the structures, are shown in the drawings.

Cameras are generally mounted in station waiting halls or subway platforms to facilitate monitoring of passenger flow conditions in different regions. However, deployment positions of the cameras and distances from the cameras to passengers will affect the surveillance effect and result in surveillance blind regions, making it impossible to accurately predict the flow direction and flow of passengers in a region, and thereby reducing the safety of intensive passenger places such as a station waiting hall, a subway platform or the like.

In a first aspect, an embodiment of the present disclosure provides a passenger flow prediction method. The passenger flow prediction method provided in the embodiment of the present disclosure may be executed by a corresponding passenger flow prediction apparatus which may be implemented in a software and/or hardware manner, and generally integrated in an electronic device.

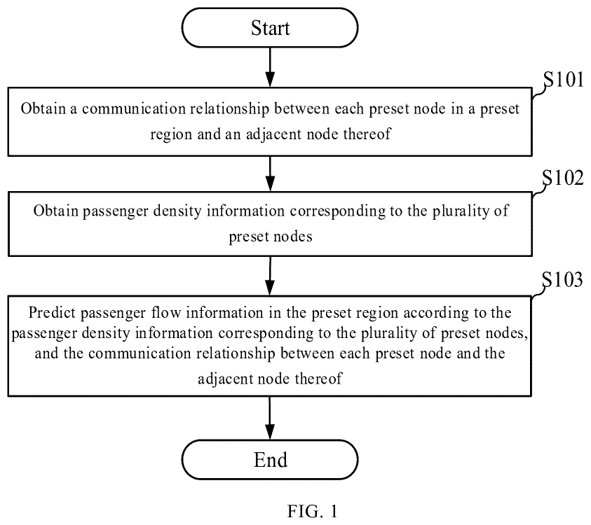

FIG. 1 shows a schematic flowchart of a passenger flow prediction method according to an embodiment of the present disclosure. As shown in FIG. 1, the passenger flow prediction method includes, but is not limited to, the following steps S101 to S103:

At step S101, obtaining a communication relationship between each preset node in a preset region and an adjacent node thereof.

The preset region includes a plurality of preset nodes and connection channels between the preset nodes.

It should be noted that one preset node is provided with at least one adjacent node, so as to determine whether the plurality of preset nodes are communicated with each other, thereby determining communication relationships between the plurality of preset nodes, where the communication relationships represent flow directions of the connection channels.

At step S102, obtaining passenger density information corresponding to the plurality of preset nodes.

The passenger density information may include the number of passengers present in the preset node in real time, a total passenger capacity of the preset node, a ratio of the number of passengers present in the preset node in real time to the total passenger capacity of the preset node, and the like.

The passenger density information can represent real-time passenger conditions in the preset node, so that passenger control in the preset node can be implemented, and passenger safety can be guaranteed.

At step S103, predicting passenger flow information in the preset region according to the passenger density information corresponding to the plurality of preset nodes, and the communication relationship between each preset node and the adjacent node thereof.

The passenger density information includes the number of passengers and passenger distribution region information in each preset node, and the like, so that a specific number of passengers in the preset node can be determined.

Depending on different communication relationships between different preset nodes, the communication relationships corresponding to the plurality of preset nodes may represent flow directions of the connection channels between the respective preset nodes, so as to determine a possible flow direction of the passengers from which preset node to which preset node.

Further, based on the number of passengers in different preset nodes during different time periods, flow directions of the passengers and the number of flowing passengers among the preset nodes in the preset region can be predicted, so that the flowing passengers can be managed and scheduled, and thus safety in the preset region can be improved.

In this embodiment, by obtaining the communication relationship between each preset node in the preset region and the adjacent node thereof, whether connection channels are present between a plurality of preset nodes in the preset region, as well as a flow direction of each connection channel, can be determined for subsequent processing; by obtaining passenger density information corresponding to the plurality of preset nodes in the preset region, the passenger density conditions in different preset nodes can be clarified to facilitate control of the number of passengers in different preset nodes, where the preset region includes a plurality of preset nodes and connection channels between the preset nodes; and by predicting passenger flow information in the preset region according to the passenger density information corresponding to the plurality of preset nodes, and the communication relationship between each preset node and the adjacent node thereof, accurate prediction of passenger flow information in the preset region can be implemented, which can help to schedule and manage the passenger flow between different preset nodes, and thus improve safety in the preset region.

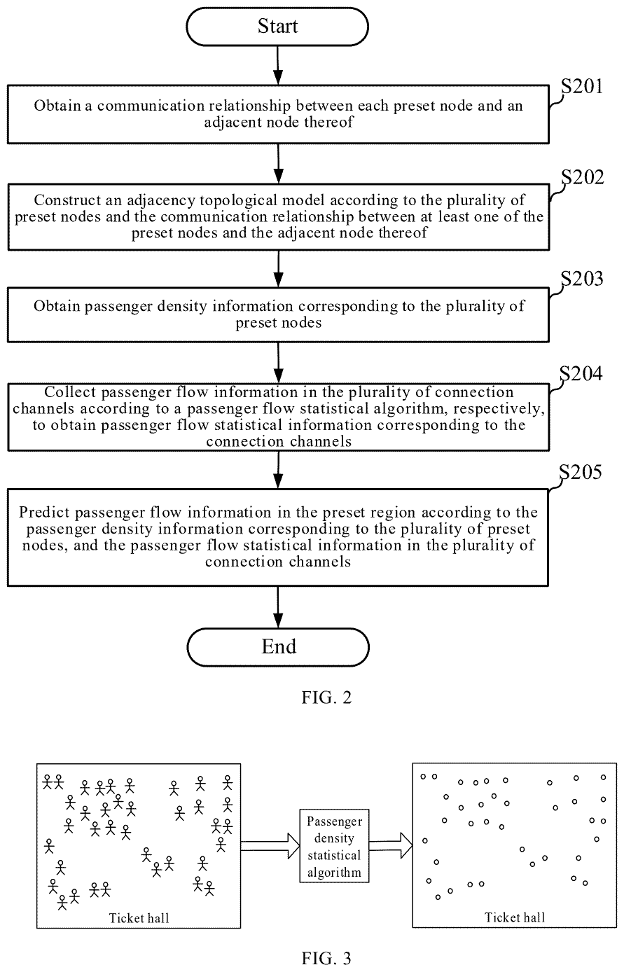

FIG. 2 shows a schematic flowchart of a passenger flow prediction method according to an embodiment of the present disclosure. The passenger flow prediction method may be applied to a passenger flow prediction apparatus. As shown in FIG. 2, the passenger flow prediction method includes, but is not limited to, the following steps S201 to S204:

At step S201, obtaining a communication relationship between each preset node and an adjacent node thereof.

It should be noted that the step S201 in this embodiment is the same as the step S101 in the previous embodiment, and thus is not repeated here.

At step S202, constructing an adjacency topological model according to the plurality of preset nodes and the communication relationship between at least one of the preset nodes and the adjacent node thereof.

The adjacency topological model is a model which takes a plurality of preset nodes as nodes and a connection channel between two adjacent preset nodes as an edge.

For example, the adjacency topological model includes 5 preset nodes (i.e., a first preset node, a second preset node, a third preset node, a fourth preset node and a fifth preset node), where the first preset node is respectively communicated with the second preset node and the third preset node, while the fourth preset node is not communicated with the fifth preset node. As a result, the constructed adjacency topological model may include a communication value (which is set to 1 for example) between the first preset node and the second preset node, a communication value (which is set to 1 for example) between the first preset node and the third preset node, a communication value (which is set to 0 for example) between the fourth preset node and the fifth preset node. Therefore, the communication relationships between the respective preset nodes can be intuitively known according to the determined adjacency topological model.

For example, the adjacency topological model is represented in an N^{th} order square matrix form, where N is an integer greater than 1. For example, the N^{th} order square matrix is a matrix of N rows and N columns. When N is equal to 3, a value of an element in a 1st row and a 1st column in the 3rd order square matrix indicates that the 1st preset node is communicated per se (i.e., the value is 1); a value of an element in row 2 at column 1 indicates whether the 2nd preset node is communicated with the 1st preset node (i.e., the value is 1 if communicated; otherwise, the value is 0); . . . , so on and so forth. In this manner, the value of each element in the 3rd order square matrix can be known, thereby intuitively obtaining the communication conditions between the respective preset nodes in the adjacency topological model.

For example, the preset nodes include: at least one of an inbound node, a safety inspection node, a ticket checking node, a waiting node or a riding platform node.

Through different types of preset nodes, different preset nodes can be processed in a multi-dimensional mode, so that the passenger flow prediction method can be applied to more use scenes, and the application range of the passenger flow prediction method is expanded.

At step S203, obtaining passenger density information corresponding to the plurality of preset nodes.

At step S204, predicting passenger flow information in the preset region according to the passenger density information corresponding to the plurality of preset nodes, and the communication relationship between each preset node and the adjacent node thereof.

It should be noted that the steps S203 to S204 in this embodiment are the same as the steps S102 to S103 in the previous embodiment, and are not repeated here.

In this embodiment, by constructing the adjacency topological model according to the plurality of preset nodes and the communication relationship between each preset node and the adjacent node thereof, the communication relationships between the plurality of preset nodes can be more intuitively determined for subsequent processing; by obtaining passenger density information corresponding to the plurality of preset nodes in the preset region, the passenger density conditions in different preset nodes can be clarified to facilitate control of the number of passengers in different preset nodes; and by predicting passenger flow information in the preset region according to the passenger density information corresponding to the plurality of preset nodes, and passenger flow statistical information in the plurality of connection channels, accurate prediction of passenger flow information in the preset region can be implemented, which can help to schedule and manage the passenger flow between different preset nodes, and thus improve safety in the preset region.

In some specific implementations, the step S102 or the step S203 of obtaining the passenger density information corresponding to the plurality of preset nodes may be implemented by: obtaining multiple frames of images to be processed; and analyzing the multiple frames of images to be processed according to a deep learning algorithm to determine the passenger density information corresponding to at least one of the preset nodes.

The images to be processed are images obtained by capturing images of passengers at each preset node with at least one image capture device provided at each preset node.

In some embodiments, at least one image capture device may be provided in each preset node to facilitate accurate capturing of images of passengers in the preset node.

For example, the preset node is a ticketing node, and FIG. 3 shows a schematic diagram of passenger density statistics in a preset node according to an embodiment of the present disclosure. As shown in FIG. 3, the left image in FIG. 3 represents an image captured by a camera mounted in the ticketing node, where it can be known that a plurality of passengers are present in the ticketing node, and different passengers correspond to different distribution regions. By analyzing the left image of FIG. 3 with a passenger density statistical algorithm, passenger distribution information as shown in the right image of FIG. 3 can be obtained (for example, the number of passengers present in the ticketing node is counted based on position information corresponding to passenger heads to obtain passenger density information, or the like).

For example, the number of passenger heads shown in the right image of FIG. 3 may be counted to obtain the number of passengers present in the ticketing node.

By analyzing and processing an image to be processed with the passenger density statistical algorithm based on a deep learning algorithm, the number of passengers and the passenger density information in the preset node can be obtained, and the passenger density in the preset node can be counted intelligently, so that real-time monitoring and management of the passengers in the preset node can be implemented, and passenger safety in the preset node can be improved.

For another example, if the preset nodes include a ticketing node and a ticket checking node, at least one image capture device provided in the ticketing node is configured to acquire images of passengers in the ticketing node, while at least one image capture device provided in the ticket checking node is configured to acquire images of passengers in the ticket checking node, so that multiple frames of images to be processed corresponding to the ticketing node and multiple frames of images to be processed corresponding to the ticket checking node can be obtained.

Further, the multiple frames of images to be processed corresponding to the ticketing node and the multiple frames of images to be processed corresponding to the ticket checking node are analyzed according to a deep learning algorithm to determine passenger density information corresponding to the ticketing node and/or passenger density information corresponding to the ticket checking node, so that passengers in the two nodes can be comprehensively scheduled.

In some specific implementations, each preset node includes: an entrance and an exit; and the step S102 or the step S203 of obtaining the passenger density information corresponding to the plurality of preset nodes may be implemented by:
obtaining first communication interaction information passing through the entrance of each preset node; obtaining second communication interaction information passing through the exit of each preset node; and determining the passenger density information corresponding to the preset node according to the first communication interaction information and the second communication interaction information.

The first communication interaction information is information between a device carried by each passenger passing through the entrance and a preset device provided at the entrance, and the second communication interaction information is information between a device carried by each passenger passing through the exit and a preset device provided at the exit.

The preset device may be a detection device provided at the entrance or the exit. For example, the preset device is a gate for swiping a card, and when a passenger passes through the entrance or exit, the first communication interaction information and the second communication interaction information can be obtained through interaction between a card to be verified (such as a ticket, a card representing identity information of the passenger, and the like) carried by the passenger and the gate.

Further, the first communication interaction information and the second communication interaction information are gathered to a server through gates at the entrance and the exit, so that the server can count the number of passengers passing through the entrance and the exit and verify identities of the passengers and the like, so that the number of inbound and outbound passengers of the preset node can be known, and thus the passenger density information corresponding to the preset node can be determined under the condition that the number of passengers in the preset node is definite in real time.

Through the above operations, the passenger density information in each preset node can be monitored in real time, so that when an abnormal condition (such as the number of passengers in the preset node exceeding a preset threshold value) occurs in the passenger flow prediction apparatus, the passengers in the preset node can be managed and controlled in time, and therefore the passenger safety is improved.

In some specific implementations, before performing the step S102 or the step S203 of obtaining the passenger density information corresponding to the plurality of preset nodes, the method further includes:
determining whether surveillance cameras are present in the plurality of connection channels; and under the condition that surveillance cameras are present in the connection channels, collecting passenger flow information in the plurality of connection channels according to a passenger flow statistical algorithm, respectively, to obtain passenger flow statistical information corresponding to the plurality of connection channels.

The passenger flow statistical algorithm may be a statistical algorithm determined based on inbound and outbound conditions of passengers, which is configured to collect passenger flow information in a plurality of connection channels so that the obtained passenger flow statistical information corresponding to the plurality of connection channels can reflect passenger flow conditions in the plurality of connection channels (for example, information such as a movement direction and the number of passengers in a certain connection channel).

For example, the passenger flow statistical information includes: the number of passengers passing through each connection channel, and a flow direction of each connection channel.

The step S103 or S204 of predicting passenger flow information in the preset region according to the passenger density information corresponding to the plurality of preset nodes, and the communication relationship between each preset node and the adjacent node thereof may be implemented by:
determining a flow direction of each connection channel according to the communication relationship between each preset node and the adjacent node thereof; determining a weight coefficient matrix corresponding to each connection channel according to the flow direction of the connection channel; determining a linear estimation model according to the weight coefficient matrix, the passenger density information and the number of passengers passing through the connection channel; and predicting the passenger flow information in the preset region according to the linear estimation model to obtain a regional flow prediction result.

The weight coefficient matrix may include a plurality of weight values, each of which represents a proportion value of movement toward a preset direction in a corresponding connection channel (for example, in the connection channel between a 1st preset node and a 2nd preset node, the proportion value may represent a proportion of passengers moving from the 1st preset node to the 2nd preset node, or represent a proportion of passengers moving from the 2nd preset node to the 1st preset node, or the like).

It should be noted that based on the communication relationship between each preset node and an adjacent node thereof, it can be determined which adjacent node has a communication relationship with a certain preset node, so as to determine which adjacent node the passengers in the preset node may flow into, and further determine a flow direction of each communication channel between the preset nodes.

By constructing a linear estimation model based on comprehensive analysis of the weight coefficient matrix, the passenger density information and the number of passengers passing through each connection channel, the passenger flow direction conditions in different preset nodes and corresponding connection channels thereof are clarified, and further, the passenger flow information in the preset region is predicted by the linear estimation model to predict the passenger flow direction conditions among the plurality of preset nodes in the preset region (i.e., a regional flow prediction result).

Based on the regional flow prediction result, information such as the possible number of passengers and possible passenger flow directions in the preset region in a future time period can be obtained, thereby facilitating control of passengers in the preset region in time. For example, when more passengers are detected in the preset region, more detection gateways may be added speed up the passenger flow and guarantee the passenger safety in the preset region; or when fewer passengers are detected in the preset region, the number of inbound passengers at the entrance may be not limited, so as to avoid idle devices or managers and increase the utilization efficiency of devices in the preset region.

In some specific implementations, the passenger flow statistical information further includes: channel statistical error information. Before predicting the passenger flow information in the preset region according to the linear estimation model to obtain the regional flow prediction result, the method further includes: adjusting the linear estimation model according to the channel statistical error information and preset total passenger flow information of the preset nodes to obtain an updated linear estimation model.

The channel statistical error information represents possible error information in statistics of passengers in the connection channels. For example, the channel statistical error information may include an identification of a connection channel, and a statistical error value corresponding to the connection channel (which may be 2, 3, or the like, for example).

By adjusting the linear estimation model according to the channel statistical error information and preset total passenger flow information of the preset nodes, the linear estimation model can be closer to the actual passenger statistical conditions in the region, so that a more accurate prediction result can be obtained when the updated linear estimation model is used for passenger prediction in the preset region.

In some specific implementations, after performing the step S103 or S204 of predicting the passenger flow information in the preset region according to the passenger density information corresponding to the plurality of preset nodes, and the communication relationship between each preset node and the adjacent node thereof, the method further includes: updating the passenger density information and the passenger flow statistical information every preset time interval.

The preset time interval may include: 1 hour, 2 hours, or the like. The above description of the preset time interval is merely exemplary, and the preset time interval may be specifically set according to the actual requirements. Other preset time intervals which are not described here also fall within the protection scope of the present disclosure, and are not described in detail here.

By updating the passenger density information and the passenger flow statistical information every preset time interval, the passenger density information of the preset nodes, and the passenger flow statistical information in the connection channels between the preset nodes and the adjacent nodes thereof can be obtained timely, thus monitoring and management of passenger conditions in different regions can be implemented.

It should be understood that the above embodiment may also be used in combination with any other manner in the embodiments of the present disclosure. The above embodiment is merely a specific example of the present disclosure, and is not intended to limit the scope of the present disclosure.

In a second aspect, an embodiment of the present disclosure provides a passenger flow prediction apparatus, which is a corresponding apparatus configured to implement any passenger flow prediction method provided in the foregoing embodiments of the present disclosure, and may be implemented in a software and/or hardware manner and generally integrated in an electronic device.

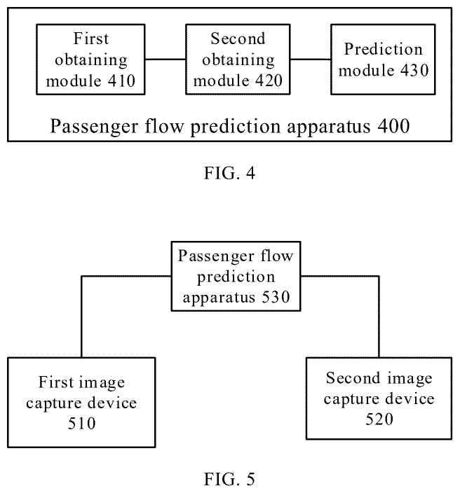

FIG. 4 shows a block diagram of a passenger flow prediction apparatus according to an embodiment of the present disclosure. As shown in FIG. 4, the passenger flow prediction apparatus 400 includes, but is not limited to, the following modules.

The first obtaining module 410 is configured to obtain a communication relationship between each preset node in a preset region and an adjacent node thereof, where the preset region includes a plurality of preset nodes and connection channels between the preset nodes, and the communication relationship represents a flow direction of a corresponding connection channel.

The second obtaining module 420 is configured to obtain passenger density information corresponding to the plurality of preset nodes.

The prediction module 430 is configured to predict passenger flow information in the preset region according to the passenger density information corresponding to the plurality of preset nodes, and passenger flow statistical information in the plurality of connection channels.

The apparatus in this implementation may execute any passenger flow prediction method provided in the embodiments of the present disclosure, the specific implementation thereof is not limited to the above embodiments, and other embodiments not described herein also fall within the protection scope of the present apparatus.

In this implementation, by the first obtaining module obtaining the communication relationship between each preset node in the preset region and the adjacent node thereof, whether connection channels are present between a plurality of preset nodes in the preset region, as well as a flow direction of each connection channel, can be determined for subsequent processing; by the second obtaining module obtaining passenger density information corresponding to the plurality of preset nodes in the preset region, the passenger density conditions in different preset nodes can be clarified to facilitate control of the number of passengers in different preset nodes, where the preset region includes a plurality of preset nodes and connection channels between the preset nodes; and by the prediction module predicting passenger flow information in the preset region according to the passenger density information corresponding to the plurality of preset nodes, and the communication relationship between each preset node and the adjacent node thereof, accurate prediction of passenger flow information in the preset region can be implemented, which can help to schedule and manage the passenger flow between different preset nodes, and thus improve safety in the preset region.

It should be noted that all modules referred to in this implementation are logic modules, and in practical applications, one logic unit may be one physical unit, or a part of one physical unit, or may be implemented by a combination of multiple physical units. In addition, in order to highlight the innovative part of the present disclosure, units which are not so closely related to solving the technical problem proposed by the present disclosure are not introduced in the implementation, but this does not indicate that no other unit is present in the implementation.

FIG. 5 shows a block diagram of a passenger flow prediction system according to an embodiment of the present disclosure. As shown in FIG. 5, the passenger flow prediction system includes, but is not limited to, the following devices.
a first image capture device 510 provided in each of a plurality of preset nodes, a second image capture device 520 provided in each of a plurality of connection channels between the preset nodes, and a passenger flow prediction apparatus 530.

The first image capture device 510 is configured to capture images of passengers in a preset node corresponding to the first image capture device 510 to obtain multiple frames of images to be processed, and send the multiple frames of images to be processed to the passenger flow prediction apparatus 530, so that the passenger flow prediction apparatus 530 analyzes the multiple frames of images to be processed according to a deep learning algorithm to determine the passenger density information corresponding to at least one of the preset nodes.

The second image capture device 520 is configured to capture a passenger movement image in a corresponding connection channel between the preset nodes, to obtain and analyze a channel image to obtain passenger flow statistical information corresponding to the connection channel, and send the passenger flow statistical information to the passenger flow prediction apparatus 530, so that the passenger flow prediction apparatus 530 collects passenger flow information in the plurality of connection channels according to a passenger flow statistical algorithm, respectively, to obtain passenger flow statistical information corresponding to the connection channel.

The passenger flow prediction apparatus 530 is configured to perform any passenger flow prediction method provided in the embodiments of the present disclosure.

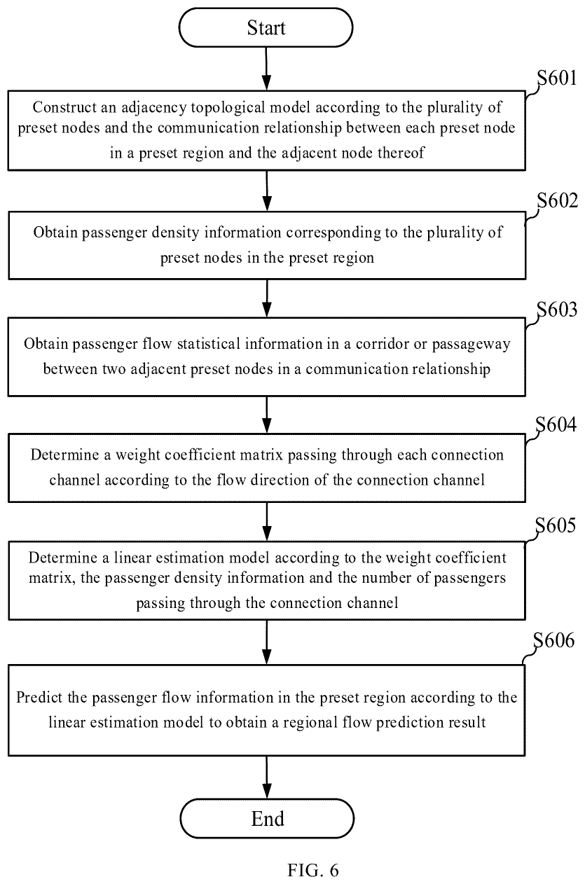

FIG. 6 shows a schematic flowchart of a working method of a passenger flow prediction system according to an embodiment of the present disclosure. As shown in FIG. 6, a working method of the passenger flow prediction system includes, but is not limited to, the following steps S601 to S606.

At step S601, constructing an adjacency topological model according to the plurality of preset nodes and the communication relationship between each preset node in a preset region and the adjacent node thereof.

The adjacency topological model may be represented in an N^{th} order square matrix form, where N is an integer greater than 1.

For example, the N^{th} order square matrix M is a matrix of N rows and N columns, and each element in the N^{th} order square matrix M may be represented by M_{(i, j)}, where a value of M_{(i, j)} indicates whether an i^{th} preset node is communicated with an j^{th} preset node, and i and j are both integers greater than or equal to 1 and less than or equal to N.

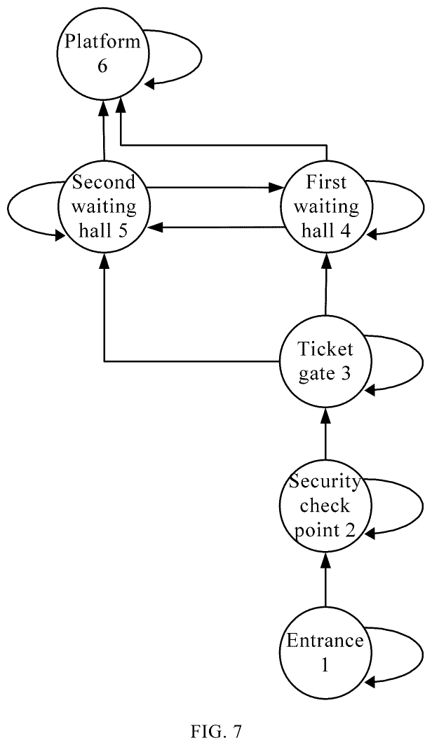

FIG. 7 shows a schematic diagram of an adjacency topological model according to an embodiment of the present disclosure. As shown in FIG. 7, the preset region (e.g., a station) includes the following preset nodes: an entrance 1, a security check point 2, a ticket gate 3, a first waiting hall 4, a second waiting hall 5, and a platform 6. The connection relationships between the preset nodes are as shown in FIG. 7, and for convenience of observation, a 6×6 matrix is constructed and taken as the adjacency topological model.

For example, the constructed adjacency topological model is expressed by:

$$M = [ \begin{matrix}1 & 1 & 0 & 0 & 0 & 0 \\ 0 & 1 & 1 & 0 & 0 & 0 \\ 0 & 0 & 1 & 1 & 1 & 0 \\ 0 & 0 & 0 & 1 & 1 & 1 \\ 0 & 0 & 0 & 1 & 1 & 1 \\ 0 & 0 & 0 & 0 & 0 & 1\end{matrix} ] \qquad ( 1 )$$

where M_{(1,1)}=1, indicating that entrance 1 is communicated to the entrance 1; M_{(1,2)}=1, indicating that the entrance 1 is communicated to the security check point 2 (i.e., there is a corridor or passageway from the entrance 1 to the security check point 2, so that a passenger can move from the entrance 1 to the security check point 2); . . . ; by analogy, M_{(6,6)}=1, indicating that the platform 6 is communicated to the platform 6.

At step S602, obtaining passenger density information corresponding to the plurality of preset nodes in the preset region.

For example, the following operations are performed for each preset node: obtaining images (i.e., multiple frames of images to be processed) of passenger in each preset node (e.g., the ticket gate 3, the first waiting hall 4, or the like) from an image capture device mounted in the preset node, and analyzing the multiple frames of images to be processed according to a deep learning algorithm to determine the passenger density information corresponding to each preset node.

At step S603, obtaining passenger flow statistical information in a corridor or passageway between two adjacent preset nodes in a communication relationship.

For example, the number of passengers and a passenger flow direction in a passageway between the security check point 2 and the ticket gate 3 are collected to obtain the passenger flow statistical information between the security check point 2 and the ticket gate 3. For example, a camera may be mounted in the corridor or passageway between the security check point 2 and the ticket gate 3 to capture and analyze images, so that the passenger flow statistical information (i.e., information such as the number of passengers and the passenger flow direction) passing through the corridor within a preset time period can be obtained.

It should be noted that the passenger flow statistical information between other adjacent preset nodes may be obtained in the same manner, and the number of passengers in the connection channel between the i^{th} preset node and the j^{th} preset node may be referred to as aᵢⱼ to facilitate subsequent use.

At step S604, determining a weight coefficient matrix passing through each connection channel according to the flow direction of the connection channel.

Based on the flow direction of each connection channel, directional flow directions between different preset nodes can be determined. For example, passengers in the entrance 1 can only flow to the security check point 2, so that a proportion value of the number of flowing passengers in the connection channel between the entrance 1 and the security check point 2 in the total capacity of the entrance 1 can be determined and used as a weight coefficient. Different connection channels may correspond to different weight coefficients.

For example, it is assumed that at time tₗ, the total capacity of the i^{th} preset node is pᵢ, and the total capacity of the j^{th} preset node is pⱼ; at time t₂, the total capacity of the i^{th} preset node is pᵢ′, and the total capacity of the j^{th} preset node is pⱼ′; and the weight coefficient matrix is set as W, where the weight coefficient matrix W includes a plurality of elements (e.g., each element is denoted as wᵢⱼ, which represents a proportion of the number of passengers flowing from the i^{th} preset node to the j^{th} preset node,

$$e . g . , {w}_{ij} = \frac{{p}_{i} - {p}_{i}^{′}}{{p}_{i}} ) ,$$

and 0≤wᵢⱼ≤1.

It should be noted that updating may be made based on a value of pᵢ corresponding to the image captured by a camera mounted in the i^{th} preset node every preset time interval, so as to obtain the number of passengers flowing from the i^{th} preset node flows to an adjacent preset node thereof.

For example, since the direction and number of flowing passengers varied in different time periods of a day in a train station, a passenger station, a subway station, or the like, the value of wᵢⱼ may be updated every preset time interval (e.g., 1 hour, 2 hours, or the like) to make the prediction result more accurate.

At step S605, determining a linear estimation model according to the weight coefficient matrix, the passenger density information and the number of passengers passing through the connection channel.

The linear estimation model represents variation values of the number of passengers in different preset nodes. For example, the linear estimation model may be expressed by:

$${m}_{i} = {\sum }_{k = 0}^{K} {w}_{ki} {a}_{ki} {p}_{k} - {\sum }_{1 = 0}^{L} {w}_{il} {a}_{il} {p}_{i} \qquad ( 2 )$$

where mᵢ represents a variation value of the number of passengers in the i^{th} preset node;

$${\sum }_{k = 0}^{K} {w}_{ki} {a}_{ki} {p}_{k}$$

represents the number of inbound passengers in the i^{th} preset node;

$${\sum }_{1 = 0}^{L} {w}_{il} {a}_{il} {p}_{i}$$

represents the number of outbound passengers in the i^{th} node. K represents the number of outbound nodes among the preset nodes, L represents the number of inbound nodes among the preset nodes, and K and L are both integers greater than or equal to 0; k is an integer greater than or equal to 0 and less than or equal to K; and l is an integer greater than or equal to 0 and less than or equal to L. i is an integer greater than or equal to 1 and less than or equal to the number of preset nodes in the preset region.

wₖᵢ represents a proportion of the number of passengers flowing from the k^{th} preset node to the i^{th} preset node at time tₗ; aₖᵢ represents the number of passengers in a connection path between the k^{th} preset node and the i^{th} preset node (i.e., the number of passengers present in the connection channel in real time) at time tₗ; and pₖ represents the number of passengers in the k^{th} preset node at time tₗ.

wᵢₗ represents a proportion of the number of passengers flowing from the i^{th} preset node to the 1th preset node; aᵢₗ represents the number of passengers in a connection path between the i^{th} preset node and the l^{th} preset node (i.e., the number of passengers present in the connection channel in real time); and pᵢ represents the number of passengers in the i^{th} preset node at time tₗ.

At step S606, predicting the passenger flow information in the preset region according to the linear estimation model to obtain a regional flow prediction result.

For example, the regional flow prediction result is obtained by minimizing a difference between an actual variation value and an estimated value of the number of passengers in the preset node by the linear estimation model.

For example, an objective function (i.e., the regional flow prediction result) may be expressed by:

$$min {‖ {\sum }_{i = 1}^{I} ( {m}_{i} - ( {p}_{i}^{′} - {p}_{1} ) ) ‖}_{1} \qquad ( 3 )$$

where min∥ ∥₁ represents that for a preset node i, 1 is used as an outbound passenger capacity to determine a minimum value of the variation values corresponding to the preset node i, so as to obtain a flow prediction result of the preset region including a plurality of preset nodes. I represents the number of preset nodes included in the preset region, I is an integer greater than or equal to 1, and i is an integer greater than or equal to 1 and less than or equal to I.

When the above formula (3) is used to determine the regional flow prediction result, the following constraint condition is required:

$${\sum }_{m = 0}^{M} {w}_{im} = 1 ;$$

which indicates that for a preset node i, the total number of outbound passengers is 1. M represents a maximum number of passenger changes in the preset node i, M is an integer greater than or equal to 1, and m is an integer greater than or equal to 0 and less than or equal to M.

In some implementations, the above prediction process may be further constrained based on channel statistical error information in a connection channel (e.g., the connection channel from the i^{th} preset node to the j^{th} preset node, or the like). For example, the channel statistical error information is expressed by:

$$- δ \leq {w}_{ij} {a}_{ij} {p}_{i} - {e}_{ij} \leq δ \qquad ( 4 )$$

where eᵢⱼ represents the number of passenger flowing from the i^{th} preset node to the j^{th} preset node (i.e., the number of passengers that have flowed into the j^{th} preset node); and δ represents a statistical error value, e.g., δ may take a value of 2, 3, or the like.

Further, the linear estimation model is adjusted according to the channel statistical error information and preset total passenger flow information of the preset nodes to obtain an updated linear estimation model. For example, the updated linear estimation model may be expressed by:

$$\{ \begin{matrix}min {‖ {\sum }_{i = 1}^{I} ( {m}_{i} - ( {p}_{i}^{′} - {p}_{1} ) ) ‖}_{1} \\ 0 \leq {w}_{ij} \leq 1 , and {\sum }_{m = 0}^{m} {w}_{im} = 1 \\ - δ \leq {w}_{ij} {a}_{ij} {p}_{i} - {e}_{ij} \leq δ\end{matrix} \qquad ( 5 )$$

where eᵢⱼ represents the number of passenger flowing from the i^{th} preset node to the j^{th} preset node (i.e., the number of passengers that have flowed into the j^{th} preset node).

It should be noted that, in formula (5), all variables except wᵢⱼ are known, and the formula (5) may be solved linearly to obtain an optimal wᵢⱼ, i.e., a proportion of the number of passengers flowing from the i^{th} preset node to the j^{th} preset node.

The number of passengers flowing from the i^{th} preset node to the j^{th} preset node can be further obtained: wᵢⱼaᵢⱼpᵢ.

In this embodiment, an adjacency topological model is constructed through a plurality of preset nodes in a preset region and the communication relationship between each preset node and an adjacent node thereof, so that the passenger flow conditions in the preset region can be predicted based on the adjacency topological model, and the passenger management in the preset region can be facilitated. Further, by analyzing the multiple frames of images to be processed captured by cameras mounted in different preset nodes according to a deep learning algorithm to determine the passenger density information corresponding to each preset node, the passenger density in the preset node can be counted intelligently, so that real-time monitoring and surveillance of the passengers in the preset node can be implemented. By predicting passenger flow information in the preset region according to the passenger density information corresponding to the plurality of preset nodes, and passenger flow statistical information in the plurality of connection channels, accurate prediction of passenger flow information in the preset region can be implemented, which can help to schedule and manage the passenger flow between different preset nodes, and thus improve safety in the preset region.

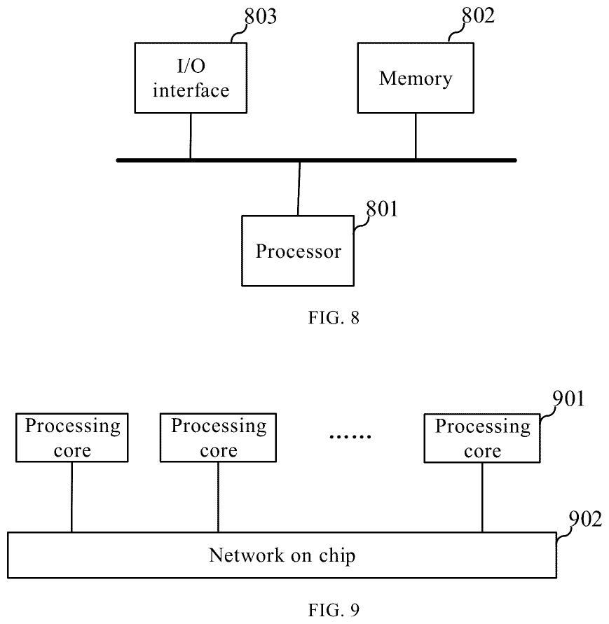

FIG. 8 shows a block diagram of an electronic device according to an embodiment of the present disclosure.

Referring to FIG. 8, an embodiment of the present disclosure provides an electronic device, including: at least one processor 801; at least one memory 802, and one or more I/O interfaces 803 connected between the processor 801 and the memory 802. The memory 802 has one or more computer programs stored thereon and executable by the at least one processor 801, which, when executed by the at least one processor 801, cause the at least one processor 801 to perform the passenger flow prediction method as described above.

In some embodiments, the at least one processor 801 can obtain a communication relationship between each preset node in a preset region and an adjacent node thereof, where the preset region includes a plurality of preset nodes and connection channels between the preset nodes, and the communication relationship represents a flow direction of a corresponding connection channel; obtain passenger density information corresponding to the plurality of preset nodes; and predict passenger flow information in the preset region according to the passenger density information corresponding to the plurality of preset nodes, and the communication relationship between each preset node and the adjacent node thereof.

It should be noted that the at least one processor 801 can implement any passenger flow prediction method provided in the embodiments of the present disclosure.

FIG. 9 shows a block diagram of an electronic device according to an embodiment of the present disclosure.

Referring to FIG. 9, an embodiment of the present disclosure provides an electronic apparatus, including a plurality of processing cores 901 and a network on chip 902. The plurality of processing cores 901 are connected to network on chip 902, respectively, and the network on chip 902 is configured for interaction between data of the plurality of processing cores and external data.

One or more of the processing cores 901 have stored thereon one or more instructions which, when executed by the one or more processing cores 901, cause the one or more processing cores 901 to implement the passenger flow prediction method as described above.

In some embodiments, the one or more processing cores 901 can obtain a communication relationship between each preset node in a preset region and an adjacent node thereof, where the preset region includes a plurality of preset nodes and connection channels between the preset nodes, and the communication relationship represents a flow direction of a corresponding connection channel; obtain passenger density information corresponding to the plurality of preset nodes; and predict passenger flow information in the preset region according to the passenger density information corresponding to the plurality of preset nodes, and the communication relationship between each preset node and the adjacent node thereof.

It should be noted that the at least one processor 801 can implement any passenger flow prediction method provided in the embodiments of the present disclosure.

An embodiment of the present disclosure further provides a computer-readable storage medium having a computer program stored thereon which, when executed by a processor/processing core, causes the passenger flow prediction method as described above to be implemented. The computer-readable storage medium may be a volatile or nonvolatile computer-readable storage medium.

An embodiment of the present disclosure further provides a computer program product including a computer-readable code or a nonvolatile computer-readable storage medium having computer-readable codes stored thereon, where the computer-readable code, when executed on a processor of an electronic device, causes the processor in the electronic device to implement the passenger flow prediction method as described above.

Those of ordinary skill in the art will appreciate that all or some steps of the above described method, functional modules/units in the system and apparatus may be implemented as software, firmware, hardware, and suitable combinations thereof. In a hardware implementation, the division between the functional modules/units mentioned in the above description does not necessarily correspond to the division of physical components; for example, one physical component may have multiple functions, or one function or step may be performed cooperatively by several physical components. Some or all physical components may be implemented as software executed by a processor, such as a CPU, a digital signal processor or microprocessor, or implemented as hardware, or implemented as an integrated circuit, such as an application specific integrated circuit. Such software may be distributed on a computer-readable storage medium which may include a computer storage medium (or non-transitory medium) or a communication medium (or transitory medium).

As is well known to those of ordinary skill in the art, the term computer storage medium includes volatile and nonvolatile, removable and non-removable medium implemented in any method or technology for storing information, such as computer-readable program instructions, data structures, program modules or other data. The computer storage medium includes, but is not limited to, a random access memory (RAM), read-only memory (ROM), an erasable programmable read-only memory (EPROM), a static random access memory (SRAM), a flash memory or any other memory technology, a portable compact disk read-only memory (CD-ROM), a digital versatile disk (DVD) or any other optical disk storage device, a magnetic cassette, a magnetic tape, a magnetic disk storage means or any other magnetic storage device, or any other medium which can be used to store the desired information and accessed by a computer. Moreover, it is well known to those ordinary skilled in the art that a communication medium typically includes computer-readable program instructions, a data structure, a program module, or other data in a modulated data signal, such as a carrier wave or other transport mechanism, and may include any information delivery medium.

The computer-readable program instructions described herein can be downloaded to respective computing/processing devices from a computer-readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer program instructions for carrying out operations of the present disclosure may be assembler instructions, instruction set architecture (ISA) instructions, machine instructions, machine-related instructions, microcodes, firmware instructions, state setting data, or source or object codes written in any combination of one or more programming languages, including an object oriented programming language such as Smalltalk, C++, or the like, and conventional procedural programming languages, such as the “C” programming language or similar programming languages. The computer-readable program instructions may execute entirely on the user computer, partly on the user computer, as a stand-alone software package, partly on the user computer and partly on a remote computer or entirely on the remote computer or server. In the latter scenario, the remote computer may be connected to the user computer through any type of network, including a local area network (LAN) or a wide area network (WAN), or by connecting to an external computer (for example, through the Internet provided by an Internet service provider). In some embodiments, aspects of the present disclosure are implemented by personalizing an electronic circuit, such as a programmable logic circuit, a field programmable gate array (FPGA), or a programmable logic array (PLA), with state information of computer-readable program instructions, which can execute the computer-readable program instructions.

The computer program product described herein may be specifically implemented in hardware, software, or a combination thereof. In an optional embodiment, the computer program product is specifically embodied in a computer storage medium, while in another optional embodiment, the computer program product is specifically embodied in a software product, such as a software development kit (SDK) or the like.

Various aspects of the present disclosure have been described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, when executed via the processor of the computer or other programmable data processing apparatus, create means for implementing the functions/acts specified in flowchart and/or block diagram block or blocks. These computer-readable program instructions may also be stored in a computer-readable storage medium, and direct a computer, a programmable data processing apparatus, and/or other devices to function in a particular manner, such that the computer-readable medium having the instructions stored therein includes an article of manufacture including instructions for implementing aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable data processing apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagram may represent a functional block, a program segment, or a portion of instructions including one or more executable instructions for implementing the specified logical function(s). In some alternative implementations, the functions shown in the blocks may occur out of the order shown in the figures. For example, two blocks shown in succession may, in fact, be executed substantially concurrently, or may sometimes be executed in the reverse order, depending upon the functionality involved. It will also be noted that each block in the block diagram and/or flowchart, and combinations of blocks in the block diagram and/or flowchart, may be implemented by a special purpose hardware-based system which performs the specified functions or acts, or by combinations of special purpose hardware and computer instructions.

The present disclosure has disclosed exemplary embodiments, and although specific terms are employed, they are used and should be interpreted merely in a generic and descriptive sense, not for purposes of limitation. In some instances, as would be apparent to one skilled in the art, features, characteristics and/or elements described in connection with a particular embodiment may be used alone or in combination with features, characteristics and/or elements described in connection with another embodiment, unless expressly stated otherwise. It will, therefore, be understood by those skilled in the art that various changes in form and details may be made therein without departing from the scope of the present disclosure as set forth in the appended claims.

1. A passenger flow prediction method, comprising:
obtaining a communication relationship between each preset node in a preset region and an adjacent node thereof, wherein the preset region comprises a plurality of preset nodes and connection channels between the preset nodes, and the communication relationship represents a flow direction of a corresponding connection channel;
obtaining passenger density information corresponding to the plurality of preset nodes; and
predicting passenger flow information in the preset region according to the passenger density information corresponding to the plurality of preset nodes, and the communication relationship between each preset node and the adjacent node thereof.

2. The method according to claim 1, wherein after obtaining the communication relationship between each preset node in the preset region and the adjacent node thereof, and before obtaining the passenger density information corresponding to the plurality of preset nodes, the method further comprises:
constructing an adjacency topological model according to the plurality of preset nodes and the communication relationship between at least one of the preset nodes and the adjacent node thereof, wherein the adjacency topological model is represented in an N^{th} order square matrix form, where N is an integer greater than 1.

3. The method according to claim 1, wherein obtaining the passenger density information corresponding to the plurality of preset nodes comprises:
obtaining multiple frames of images to be processed, wherein the images to be processed are images obtained by capturing images of passengers at each preset node with at least one image capture device provided at each preset node; and
analyzing the multiple frames of images to be processed according to a deep learning algorithm to determine the passenger density information corresponding to at least one of the preset nodes.

4. The method according to claim 1, wherein before obtaining the passenger density information corresponding to the plurality of preset nodes, the method further comprises:
determining whether surveillance cameras are present in the plurality of connection channels; and
under the condition that surveillance cameras are present in the connection channels, collecting passenger flow information in the plurality of connection channels according to a passenger flow statistical algorithm, respectively, to obtain passenger flow statistical information corresponding to the plurality of connection channels.

5. The method according to claim 4, wherein the passenger flow statistical information comprises: the number of passengers passing through each connection channel; and
predicting the passenger flow information in the preset region according to the passenger density information corresponding to the plurality of preset nodes, and the communication relationship between each preset node and the adjacent node thereof comprises:
determining a flow direction of each connection channel according to the communication relationship between each preset node and the adjacent node thereof;
determining a weight coefficient matrix corresponding to each connection channel according to the flow direction of the connection channel;
determining a linear estimation model according to the weight coefficient matrix, the passenger density information and the number of passengers passing through the connection channel; and
predicting the passenger flow information in the preset region according to the linear estimation model to obtain a regional flow prediction result.

6. The method according to claim 5, wherein the passenger flow statistical information further comprises: channel statistical error information; and
before predicting the passenger flow information in the preset region according to the linear estimation model to obtain the regional flow prediction result, the method further comprises:
adjusting the linear estimation model according to the channel statistical error information and preset total passenger flow information of the preset nodes to obtain an updated linear estimation model.

7. The method according to claim 4, wherein after predicting the passenger flow information in the preset region according to the passenger density information corresponding to the plurality of preset nodes, and the communication relationship between each preset node and the adjacent node thereof, the method further comprises:
updating the passenger density information and/or the passenger flow statistical information every preset time interval.

8. The method according to claim 1, wherein each preset node comprises: an entrance and an exit; and
obtaining the passenger density information corresponding to the plurality of preset nodes comprises:
obtaining first communication interaction information passing through the entrance of each preset node, wherein the first communication interaction information is information between a device carried by each passenger passing through the entrance and a preset device provided at the entrance,
obtaining second communication interaction information passing through the exit of each preset node, wherein the second communication interaction information is information between a device carried by each passenger passing through the exit and a preset device provided at the exit; and
determining the passenger density information corresponding to the preset node according to the first communication interaction information and the second communication interaction information;
wherein the preset nodes comprise: at least one of an inbound node, a safety inspection node, a ticket checking node, a waiting node or a riding platform node.

9. A passenger flow prediction apparatus, comprising:
a first obtaining module configured to obtain a communication relationship between each preset node in a preset region and an adjacent node thereof, wherein the preset region comprises a plurality of preset nodes and connection channels between the preset nodes, and the communication relationship represents a flow direction of a corresponding connection channel;
a second obtaining module configured to obtain passenger density information corresponding to the plurality of preset nodes; and
a prediction module configured to predict passenger flow information in the preset region according to the passenger density information corresponding to the plurality of preset nodes, and passenger flow statistical information in the plurality of connection channels.

10. A passenger flow prediction system, comprising: a first image capture device provided in each of a plurality of preset nodes, a second image capture device provided in each of a plurality of connection channels between the preset nodes, and a passenger flow prediction apparatus; wherein
the first image capture device is configured to capture images of passengers in a preset node corresponding to the first image capture device to obtain multiple frames of images to be processed, and send the multiple frames of images to be processed to the passenger flow prediction apparatus, so that the passenger flow prediction apparatus analyzes the multiple frames of images to be processed according to a deep learning algorithm to determine the passenger density information corresponding to at least one of the preset nodes;
the second image capture device is configured to capture a passenger movement image in a corresponding connection channel between the preset nodes, to obtain and analyze a channel image to obtain passenger flow statistical information corresponding to the connection channel, and send the passenger flow statistical information to the passenger flow prediction apparatus, so that the passenger flow prediction apparatus collects passenger flow information in the plurality of connection channels according to a passenger flow statistical algorithm, respectively, to obtain passenger flow statistical information corresponding to the connection channel; and
the passenger flow prediction apparatus is configured to perform the passenger flow prediction method according to claim 1.
